(19) United States
(12) Patent Application Publication
(10) Pub. No.: US 2025/0357533 A1
(43) Pub. Date: Nov. 20, 2025

(54) NEW Li-CONDUCTOR PROTOTYPES IN THE Li-Hf-O CHEMICAL SPACE FOR ALL-SOLID-STATE BATTERIES

(71) Applicant: SAMSUNG ELECTRONICS CO., LTD., Suwon-si (KR)

(72) Inventors: Mahdi AMACHRAA, Cambridge, MA (US); Yan WANG, Brookline, MA (US)

(73) Assignee: SAMSUNG ELECTRONICS CO., LTD., Suwon-si (KR)

(21) Appl. No.: 18/890,460

(22) Filed: Sep. 19, 2024

Related U.S. Application Data
(60) Provisional application No. 63/648,497, filed on May 16, 2024.

(51) Int. Cl. H01M 10/0562; H01M 4/04; H01M 10/0525

(52) U.S. Cl. CPC H01M 10/0562; H01M 4/0402; H01M 10/0525; H01M 2300/0071

(57) ABSTRACT

A lithium hafnium oxide has one of the following parent compositions: Li_{6-z}Hf₂₋ₓMₓO₇ crystallized in space group P2₁/c, Li_{8-z}Hf₁₋ₓMₓO₆ crystallized in space group R-3, Li_{2-z}Hf₁₋ₓMₓO₃, Li_{4-z}Hf₃₋ₓMₓO₈, Li_{6-z}Hf₁₋ₓMₓO₅, or Li_{4-z}Hf₁₋ₓMₓO₄ crystallized in space group P-1 or Cmcm, wherein M can be either a one-way, two-way or three-way combination of the following species: Sc³⁺, Y³⁺, Lu³⁺, Ti³⁺, Ti⁴⁺, Zr⁴⁺, Ta³⁺, Ta⁴⁺, Ta⁵⁺, Cr³⁺, Cr⁴⁺, Cr⁵⁺, Fe³⁺, Fe⁴⁺, Mn³⁺, A1³⁺, Ga³⁺, In³⁺, La³⁺, Ce⁴⁺, Ce³⁺, wherein charge neutrality is satisfied, and wherein −1<z<1 and x can be from 0 to the maximum stoichiometric amount of hafnium in each respective compound. A lithium solid-state battery includes an anode, a cathode, and a solid electrolyte, wherein the solid electrolyte includes the aforementioned lithium hafnium oxide.

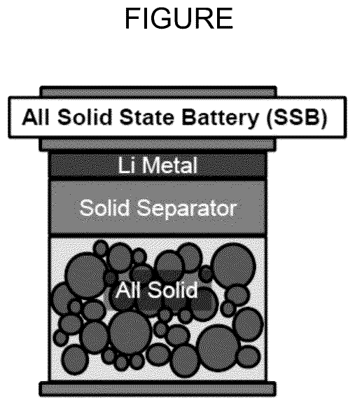

### CROSS-REFERENCE TO RELATED APPLICATION

This application is based on and claims priority from U.S. Provisional Application No. 63/648,497 filed on May 16, 2024 in the U.S. Patent and Trademark Office, the disclosure of which is incorporated herein by reference in its entirety.

### BACKGROUND

### 1. Field

Materials according to embodiments relate to ionic conductors for use as solid electrolytes in Li solid-state batteries and/or for use as electrode coatings for solid-state batteries.

### 2. Description of the Related Art

The fast development of portable electronics and electric vehicles has increased the demand for electrochemical energy storage system. In the meantime, the related safety issues are gathering more attention.

Due to the flammability and possible leakage, organic liquid electrolytes pose a safety risk in conventional Li-ion batteries. In this context, solid-state batteries (SSBs) are considered to be the next-generation batteries with improved safety and energy density. An all solid state battery is shown in the FIGURE. In the FIGURE, the all solid component can comprise solid cathode particles in a solid catholyte, and the solid separator can comprise a solid electrolyte.

Solid-state lithium-ion conductors with high ionic conductivities play an important role in SSBs. During the past two decades, there has been an increasing amount of work on new solid-state lithium-ion conductors (SSLICs). And most of them are focused on sulfide SSLICs with high ionic conductivities. However, very limited number of oxide materials were developed for SSBs, and so far only lithium garnet is considered to be the oxide-type electrolyte for lithium SSBs.

For solid-state electrolytes in SSBs, sulfide-based materials have high ionic conductivities (>10 mS/cm) but not really safe (H₂S in air condition) and have limited electrochemical stability (for example, unstable against Li metal).

Oxide SSLICs, which own better electrochemical and chemical stability than sulfide SSLICs, have been largely limited in garnet-type materials. The ionic conductivities of reported oxide SSLICs are generally lower than those of sulfide SSLICs.

Solid state electrolyte materials with superionic conductivity and interfacial stability are desirable materials to form all-solid-state Li-metal batteries. However, several problems and challenges are currently being investigated, such as achieving high ionic conductivity at room temperature, ensuring good interfaces between solid-state electrolytes and electrode materials, developing cost-effective solid-state-electrolytes that can compete with currently established liquid electrolyte technologies is also a hurdle for widespread adoption. Currently, very few Li-oxide conductors have been uncovered. Consequently, discovering new compositions within the Li—Hf—O chemical space is a promising venture to uncover simple, cost-effective, high stability Li-conductors.

Information disclosed in this Background section has already been known to the inventors before achieving the disclosure of the present application or is technical information acquired in the process of achieving the disclosure. Therefore, it may contain information that does not form the prior art that is already known to the public.

### SUMMARY

The present disclosure focuses on presenting novel compositions within the Li—Hf—O chemical space by applying a machine learning-based crystal structure prediction algorithm.

In this disclosure, novel lithium hafnium oxides include the following parent compositions: Li_{6-z}Hf₂₋ₓMₓO₇, Li_{8-z}Hf₁₋ₓMₓO₆, Li_{2-z}Hf₁₋ₓMₓO₃, Li_{4-z}Hf₃₋ₓMₓO₈, Li_{6-z}Hf₁₋ₓMₓO₅, Li_{4-z}Hf₁₋ₓMₓO₄, where M can be either a one-way, two-way or three-way combination of the following species: Sc³⁺, Y³⁺, Lu³⁺, Ti³⁺, Ti⁴⁺, Zr⁴⁺, Ta³⁺, Ta⁴⁺, Ta⁵⁺, Cr³⁺, Cr⁴⁺, Cr⁵⁺, Fe³⁺, Fe⁴⁺, Mn³⁺, Al¹³⁺, Ga³⁺, In³⁺, La³⁺, Ce⁴⁺, Ce³⁺ where charge neutrality is satisfied. Here, −1<z<1, while x can span from 0 to the maximum stoichiometric amount of hafnium in each respective compound.

In a more particular embodiment in this disclosure, novel lithium hafnium oxides include the following parent compositions: Li_{8-z}Hf₁₋ₓMₓO₆, Li_{2-z}Hf₁₋ₓMₓO₃, Li_{4-z}Hf₃₋ₓMₓO₈, Li_{6-z}Hf₁₋ₓMₓO₅, Li_{4-z}Hf₁₋ₓMₓO₄, where M can be either a one-way, two-way or three-way combination of the following species: Sc³⁺, Y³⁺, Lu³⁺, Ti³⁺, Ti⁴⁺, Zr⁴⁺, Ta³⁺, Ta⁴⁺, Ta⁵⁺, Cr³⁺, Cr⁴⁺, Cr⁵⁺, Fe³⁺, Fe⁴⁺, Mn³⁺, Al¹³⁺, Ga³⁺, In³⁺, La³⁺, Ce⁴⁺, Ce³⁺, where charge neutrality is satisfied, and where −1<z<1 and x can be from 0 to the maximum stoichiometric amount of hafnium in each respective compound.

In a still more particular embodiment in this disclosure, novel lithium hafnium oxides include the following parent compositions: Li_{2-z}Hf₁₋ₓMₓO₃, Li_{4-z}Hf₃₋ₓMₓO₈, Li_{6-z}Hf₁₋ₓMₓO₅, where M can be either a one-way, two-way or three-way combination of the following species: Sc³⁺, Y³⁺, Lu³⁺, Ti³⁺, Ti⁴⁺, Zr⁴⁺, Ta³⁺, Ta⁴⁺, Ta⁵⁺, Cr³⁺, Cr⁴⁺, Cr⁵⁺, Fe³⁺, Fe⁴⁺, Mn³⁺, Al¹³⁺, Ga³⁺, In³⁺, La³⁺, Ce⁴⁺, Ce³⁺, where charge neutrality is satisfied, and where −1<z<1 and x can be from 0 to the maximum stoichiometric amount of hafnium in each respective compound.

This disclosure demonstrates several novel compositions within the Li—Hf—O chemical space with Li-ion conductivity, as well as approaches to optimize the compositions through multi-component doping of the Hf⁴⁺ as a way to increase configurational entropy, Li-ion conductivity and introduce cheaper elements.

The lithium hafnium oxides in this disclosure can be used as a solid electrolyte material for Li batteries.

This disclosure provides lower cost/high conductivity and high aqueous stability solid electrolyte for use in Li solid-state batteries.

A first embodiment of the present disclosure provides a lithium hafnium oxide of one of the following parent compositions: Li_{6-z}Hf₂₋ₓMₓO₇ crystallized in space group P2₁/c, Li_{8-z}Hf₁₋ₓMₓO₆ crystallized in space group R-3, Li_{2-z}Hf₁₋ₓMₓO₃, Li_{4-z}Hf₃₋ₓMₓO₈, Li_{6-z}Hf₁₋ₓMₓO₅, or Li_{4-z}Hf₁₋ₓMₓO₄ crystallized in space group P-1 or Cmcm, wherein M can be either a one-way, two-way or three-way combination of the following species: Sc³⁺, Y³⁺, Lu³⁺, Ti³⁺, Ti⁴⁺, Zr⁴⁺, Ta³⁺, Ta⁴⁺, Ta⁵⁺, Cr³⁺, Cr⁴⁺, Cr⁵⁺, Fe³⁺, Fe⁴⁺, Mn³⁺, Al³⁺, Ga³⁺, In³⁺, La³⁺, Ce⁴⁺, Ce³⁺, wherein charge neutrality is satisfied, and wherein −1<z<1 and x can be from 0 to the maximum stoichiometric amount of hafnium in each respective compound.

A second embodiment of the present disclosure provides a lithium hafnium oxide of the first embodiment, wherein the lithium hafnium oxide is a lithium hafnium oxide of the parent composition Li_{6-z}Hf₂₋ₓMₓO₇ crystallized in space group P2₁/c, wherein M can be either a one-way, two-way or three-way combination of the following species: Sc³⁺, Y³⁺, Lu³⁺, Ti³⁺, Ti⁴⁺, Zr⁴⁺, Ta³⁺, Ta⁴⁺, Ta⁵⁺, Cr³⁺, Cr⁴⁺, Cr⁵⁺, Fe³⁺, Fe⁴⁺, Mn³⁺, Al¹³⁺, Ga³⁺, In³⁺, La³⁺, Ce⁴⁺, Ce³⁺, wherein charge neutrality is satisfied, and wherein −1<z<1 and x can be from 0 to the maximum stoichiometric amount of hafnium in each respective compound.

A third embodiment of the present disclosure provides a lithium hafnium oxide of the first embodiment, wherein the lithium hafnium oxide is a lithium hafnium oxide of the parent composition Li_{8-z}Hf₁₋ₓMₓO₆ crystallized in space group R-3, wherein M can be either a one-way, two-way or three-way combination of the following species: Sc³⁺, Y³⁺, Lu³⁺, Ti³⁺, Ti⁴⁺, Zr⁴⁺, Ta³⁺, Ta⁴⁺, Ta⁵⁺, Cr³⁺, Cr++, Cr⁵⁺, Fe³⁺, Fe⁴⁺, Mn³⁺, Al³⁺, Ga³⁺, In³⁺, La³⁺, Ce⁴⁺, Ce³⁺, wherein charge neutrality is satisfied, and wherein −1<z<1 and x can be from 0 to the maximum stoichiometric amount of hafnium in each respective compound.

A fourth embodiment of the present disclosure provides a lithium hafnium oxide of the first embodiment, wherein the lithium hafnium oxide is a lithium hafnium oxide of the parent composition Li_{2-z}Hf₁₋ₓMₓO₃, wherein M can be either a one-way, two-way or three-way combination of the following species: Sc³⁺, Y³⁺, Lu³⁺, Ti³⁺, Ti⁴⁺, Zr⁴⁺, Ta³⁺, Ta⁴⁺, Ta⁵⁺, Cr³⁺, Cr⁴⁺, Cr⁵⁺, Fe³⁺, Fe⁴⁺, Mn³⁺, Al¹³⁺, Ga³⁺, In³⁺, La³⁺, Ce⁴⁺, Ce³⁺, wherein charge neutrality is satisfied, and wherein −1<z<1 and x can be from 0 to the maximum stoichiometric amount of hafnium in each respective compound.

A fifth embodiment of the present disclosure provides a lithium hafnium oxide of the first embodiment, wherein the lithium hafnium oxide is a lithium hafnium oxide of the parent composition Li_{4-z}Hf₃₋ₓMₓO₈, wherein M can be either a one-way, two-way or three-way combination of the following species: Sc³⁺, Y³⁺, Lu³⁺, Ti³⁺, Ti⁴⁺, Zr⁴⁺, Ta³⁺, Ta⁴⁺, Ta⁵⁺, Cr³⁺, Cr⁴⁺, Cr⁵⁺, Fe³⁺, Fe⁴⁺, Mn³⁺, Al³⁺, Ga³⁺, In³⁺, La³⁺, Ce⁴⁺, Ce³⁺, wherein charge neutrality is satisfied, and wherein −1<z<1 and x can be from 0 to the maximum stoichiometric amount of hafnium in each respective compound.

A sixth embodiment of the present disclosure provides a lithium hafnium oxide of the first embodiment, wherein the lithium hafnium oxide is a lithium hafnium oxide of the parent composition Li_{6-z}Hf₁₋ₓMₓO₅, wherein M can be either a one-way, two-way or three-way combination of the following species: Sc³⁺, Y³⁺, Lu³⁺, Ti³⁺, Ti⁴⁺, Zr⁴⁺, Ta³⁺, Ta⁴⁺, Ta⁵⁺, Cr³⁺, Cr⁴⁺, Cr⁵⁺, Fe³⁺, Fe⁴⁺, Mn³⁺, Al³⁺, Ga³⁺, In³⁺, La³⁺, Ce⁴⁺, Ce³⁺, wherein charge neutrality is satisfied, and wherein −1<z<1 and x can be from 0 to the maximum stoichiometric amount of hafnium in each respective compound.

A seventh embodiment of the present disclosure provides a lithium hafnium oxide of the first embodiment, wherein the lithium hafnium oxide is a lithium hafnium oxide of the parent composition Li_{4-z}Hf₁₋ₓMₓO₄ crystallized in space group P-1 or Cmcm, wherein M can be either a one-way, two-way or three-way combination of the following species: Sc³⁺, Y³⁺, Lu³⁺, Ti³⁺, Ti⁴⁺, Zr⁴⁺, Ta³⁺, Ta⁴⁺, Ta⁵⁺, Cr³⁺, Cr⁴⁺, Cr⁵⁺, Fe³⁺, Fe⁴⁺, Mn³⁺, Al¹³⁺, Ga³⁺, In³⁺, La³⁺, Ce⁴⁺, Ce³⁺, wherein charge neutrality is satisfied, and wherein −1<z<1 and x can be from 0 to the maximum stoichiometric amount of hafnium in each respective compound.

An eighth embodiment of the present disclosure provides a lithium hafnium oxide of the first embodiment, wherein the lithium hafnium oxide is Li₆Hf₂O₇ crystallized in space group P2₁/c.

A ninth embodiment of the present disclosure provides a lithium hafnium oxide of the first embodiment, wherein the lithium hafnium oxide is Li₈HfO₆ crystallized in space group R-3.

A tenth embodiment of the present disclosure provides a lithium hafnium oxide of the first embodiment, wherein the lithium hafnium oxide is Li₂HfO₃.

An eleventh embodiment of the present disclosure provides a lithium hafnium oxide of the first embodiment, wherein the lithium hafnium oxide is Li₄Hf₃O₈.

A twelfth embodiment of the present disclosure provides a lithium hafnium oxide of the first embodiment, wherein the lithium hafnium oxide is Li₆HfO₅.

A thirteenth embodiment of the present disclosure provides a lithium hafnium oxide of the first embodiment, wherein the lithium hafnium oxide is Li₄HfO₄ crystallized in space group P-1 or Cmcm.

A fourteenth embodiment of the present disclosure provides a lithium hafnium oxide of the first embodiment, wherein the lithium hafnium oxide is: Li₆Hf₂O₇ crystallized in space group P2₁/c, Li₈HfO₆ crystallized in space group R-3, Li₂HfO₃ crystallized in space group C2/c, Li₂HfO₃ crystallized in space group P6₃/mcm, Li₂HfO₃ crystallized in space group Cmce, Li₄Hf₃O₈ crystallized in space group P4₁32, Li₄Hf₃O₈ crystallized in space group R-3m, Li₆HfO₅ crystallized in space group 14 mm, Li₆HfO₅ crystallized in space group P-1, Li₆HfO₅ crystallized in space group Cmcm, Li₄HfO₄ crystallized in space group P-1, or Li₄HfO₄ crystallized in space group Cmcm.

A fifteenth embodiment of the present disclosure provides a lithium solid-state battery comprising an anode, a cathode, and a solid electrolyte, wherein the solid electrolyte comprises a lithium hafnium oxide of the first embodiment.

A sixteenth embodiment of the present disclosure provides a lithium solid-state battery of the fifteenth embodiment, wherein the solid electrolyte comprises Li₆Hf₂O₇ crystallized in space group P2₁/c, Li₈HfO₆ crystallized in space group R-3, Li₂HfO₃, Li₄Hf₃O₈, Li₆HfO₅, Li₄HfO₄ crystallized in space group P-1, or Li₄HfO₄ crystallized in space group Cmcm.

A seventeenth embodiment of the present disclosure provides a lithium solid-state battery of the fifteenth embodiment, wherein the solid electrolyte comprises Li₂HfO₃, Li₄Hf₃O₈, or Li₆HfO₅.

An eighteenth embodiment of the present disclosure provides a lithium solid-state battery comprising an anode, a cathode, and a solid electrolyte, wherein at least one of the anode and the cathode is coated with a coating which comprises a lithium-containing oxide of the first embodiment.

A nineteenth embodiment of the present disclosure provides a lithium solid-state batter of the eighteenth embodiment, wherein the coating comprises Li₆Hf₂O₇ crystallized in space group P2₁/c, Li₈HfO₆ crystallized in space group R-3, Li₂HfO₃, Li₄Hf₃O₈, Li₆HfO₅, or Li₄HfO₄ crystallized in space group P-1 or Cmcm.

A twentieth embodiment of the present disclosure provides a lithium solid-state batter of the eighteenth embodiment, wherein the cathode is coated with the coating which comprises the lithium-containing oxide.

### BRIEF DESCRIPTION OF DRAWINGS

Example embodiments of the present disclosure will be more clearly understood from the following detailed description taken in conjunction with the accompanying drawing in which:

The FIGURE shows an all solid-state battery.

### DETAILED DESCRIPTION OF EXAMPLE EMBODIMENTS

The present disclosure demonstrates several novel compositions within the Li—Hf—O chemical space with Li-ion conductivity.

In this disclosure, novel lithium hafnium oxides include the following parent compositions: Li_{6-z}Hf₂₋ₓMₓO₇, Li_{2-z}Hf₁₋ₓMₓO₆, Li_{2-z}Hf₁₋ₓMₓO₃, Li_{4-z}Hf₃₋ₓMₓO₈, Li_{6-z}Hf₁₋ₓMₓO₅, Li_{4-z}Hf₁₋ₓMₓO₄, where M can be either a one-way, two-way or three-way combination of the following species: Sc³⁺, Y³⁺, Lu³⁺, Ti³⁺, Ti⁴⁺, Zr⁴⁺, Ta³⁺, Ta⁴⁺, Ta⁵⁺, Cr³⁺, Cr⁴⁺, Cr⁵⁺, Fe³⁺, Fe⁴⁺, Mn³⁺, Al³⁺, Ga³⁺, In³⁺, La³⁺, Ce⁴⁺, Ce³⁺, where charge neutrality is satisfied, and where −1<z<1 and x can span from 0 to the maximum stoichiometric amount of hafnium in each respective compound.

In a more particular embodiment in this disclosure, novel lithium hafnium oxides include the following parent compositions: Li_{8-z}Hf₁₋ₓMₓO₆, Li_{2-z}Hf₁₋ₓMₓO₃, Li_{4-z}Hf₃₋ₓMₓO₈, Li_{6-z}Hf₁₋ₓMₓO₅, Li_{4-z}Hf₁₋ₓMₓO₄, where M can be either a one-way, two-way or three-way combination of the following species: Sc³⁺, Y³⁺, Lu³⁺, Ti³⁺, Ti⁴⁺, Zr⁴⁺, Ta³⁺, Ta⁴⁺, Ta⁵⁺, Cr³⁺, Cr⁴⁺, Cr⁵⁺, Fe³⁺, Fe⁴⁺, Mn³⁺, Al¹³⁺, Ga³⁺, In³⁺, La³⁺, Ce⁴⁺, Ce³⁺, where charge neutrality is satisfied, and where −1<z<1 and x can be from 0 to the maximum stoichiometric amount of hafnium in each respective compound.

In a still more particular embodiment in this disclosure, novel lithium hafnium oxides include the following parent compositions: Li_{2-z}Hf₁₋ₓMₓO₃, Li_{4-z}Hf₃₋ₓMₓO₈, Li_{6-z}Hf₁₋ₓMₓO₅, where M can be either a one-way, two-way or three-way combination of the following species: Sc³⁺, Y³⁺, Lu³⁺, Ti³⁺, Ti⁴⁺, Zr⁴⁺, Ta³⁺, Ta⁴⁺, Ta⁵⁺, Cr³⁺, Cr⁴⁺, Cr⁵⁺, Fe³⁺, Fe⁴⁺, Mn³⁺, Al³⁺, Ga³⁺, In³⁺, La³⁺, Ce⁴⁺, Ce³⁺, where charge neutrality is satisfied, and where −1<z<1 and x can be from 0 to the maximum stoichiometric amount of hafnium in each respective compound.

In this disclosure, novel Li-ion prototypes within the Li—Hf—O chemical space include the following parent formulas: Li₆Hf₂O₇, Li₈HfO₆, Li₂HfO₃, Li₄Hf₃O₈, Li₆HfO₅, Li₄HfO₄.

In a more particular embodiment in this disclosure, novel Li-ion prototypes within the Li—Hf—O chemical space include the following parent formulas: Li₈HfO₆, Li₂HfO₃, Li₄Hf₃O₈, Li₆HfO₅, Li₄HfO₄.

In a still more particular embodiment in this disclosure, novel Li-ion prototypes within the Li—Hf—O chemical space include the following parent formulas: Li₂HfO₃, Li₄Hf₃O₈, Li₆HfO₅.

Li₆Hf₂O₇ crystallizes in the monoclinic P2₁/c space group or the C2/c space group.
Crystal Structure Description of P2₁/c: There are three inequivalent Li¹⁺ sites. In the first Li¹⁺ site, Li(1)¹⁺ is bonded to one O(1)²⁻, one O(2)²⁻, one O(4)²⁻, and two equivalent O(3)²⁻ atoms to form LiO₅ square pyramids that share corners with three equivalent Li(1)O₅ square pyramids, corners with four equivalent Li(2)O₅ square pyramids, edges with four equivalent Hf(1)O₆ octahedra, and edges with two equivalent Li(2)O₅ square pyramids.
Properties of P2₁/c:
   The Li₆Hf₂O₇ parent prototype has an energy above hull (Eₕᵤₗₗ) of 5.41 meV/atom.
   Li activation energy barrier of 0.61 eV (1-dimensional), 0.99 eV (2-dimensional), 0.99 eV (3-dimensional).
   The reduction potential against lithium is 0 V, suggesting a high stability against Li metal, while the oxidation potential is 3.22 V (in batteries, this material as solid-state electrolyte can form solid-electrolyte interphases by chemical reaction with electrodes and widen the redox potential window of the electrolyte; this applies to the materials below as well).
   The reaction energy between the Li₆Hf₂O₇ prototype and water (H₂O) is −0.18 eV/atom, suggesting a relatively stable compound against water.
Crystal Structure Description of C2/c: There are three inequivalent Li1+ sites. In the first Li1+ site, Li(1)1+ is bonded to one O(2)2−, two equivalent O(3)2−, and two equivalent O(4)2− atoms to form LiO5 square pyramids that share corners with two equivalent Li(1)O5 square pyramids, corners with two equivalent Li(3)O5 square pyramids, corners with five equivalent Li(2)O5 square pyramids, edges with four equivalent Hf(1)O6 octahedra, an edge-edge with one Li(1)O5 square pyramid, an edge-edge with one Li(2)O5 square pyramid, and edges with two equivalent Li(3)O5 square pyramids. The Li(1)-O(2) bond length is 2.15 Å. There is one shorter (2.01 Å) and one longer (2.03 Å) Li(1)-O(3) bond length. There is one shorter (2.13 Å) and one longer (2.25 Å) Li(1)-O(4) bond length. In the second Li1+ site, Li(2)1+ is bonded to one O(1)2−, one O(2)2−, one O(4)2−, and two equivalent O(3)2− atoms to form LiO5 square pyramids that share a corner-corner with one Li(2)O5 square pyramid, corners with three equivalent Li(3)O5 square pyramids, corners with five equivalent Li(1)O5 square pyramids, edges with four equivalent Hf(1)O6 octahedra, an edge-edge with one Li(1)O5 square pyramid, an edge-edge with one Li(2)O5 square pyramid, and edges with two equivalent Li(3)O5 square pyramids.
Properties of C2/c:
   The Li₆Hf₂O₇ parent prototype has an energy above hull (Eₕᵤₗₗ) of 3.7 meV/atom.
   Li activation energy barrier of 0.62 eV (1-dimensional), 1.10 eV (2-dimensional), 1.10 eV (3-dimensional).
   The reduction potential against lithium is 0 V, suggesting a high stability against Li metal, while the oxidation potential is 3.77 V.
   The reaction energy between the Li₆Hf₂O₇ prototype and water is −0.18 eV/atom, suggesting a relatively good water stability.

Li₈HfO₆ crystallizes in the trigonal R-3 space group.
Crystal Structure Description: There are two inequivalent Li¹⁺ sites. In the first Li¹⁺ site, Li(1)¹⁺ is bonded to four equivalent O(1)²⁻ atoms to form LiO₄ tetrahedra that share corners with two equivalent Hf(1)O₆ octahedra, corners with four equivalent Li(2)O₆ octahedra, corners with six equivalent Li(1)O₄ tetrahedra, an edge-edge with one Hf(1)O₆ octahedra, edges with two equivalent Li(2)O₆ octahedra, and edges with three equivalent Li(1)O₄ tetrahedra. The corner-sharing octahedral tilt angles range from 18-61°. There are a spread of Li(1)-O(1) bond distances ranging from 1.92-2.01 Å. In the second Li¹⁺ site, Li(2)¹⁺ is bonded to six equivalent O(1)²⁻ atoms to form LiO₆ octahedra that share corners with twelve equivalent Li(1)O₄ tetrahedra, edges with three equivalent Li(2)O₆ octahedra, edges with three equivalent Hf(1)O₆ octahedra, and edges with six equivalent Li(1)O₄ tetrahedra. There are three shorter (2.15 Å) and three longer (2.44 Å) Li(2)-O(1) bond lengths. Hf(1)⁴⁺ is bonded to six equivalent O(1)²⁻ atoms to form HfO₆ octahedra that share corners with twelve equivalent Li(1)O₄ tetrahedra, edges with six equivalent Li(2)O₆ octahedra, and edges with six equivalent Li(1)O₄ tetrahedra. All Hf(1)-O(1) bond lengths are 2.12 Å. O(1)²⁻ is bonded in a 7-coordinate geometry to two equivalent Li(2)¹⁺, four equivalent Li(1)¹⁺, and one Hf(1)⁴⁺ atom.
Properties:
   The Li₈HfO₆ parent composition an Ehull of 6.80 meV/atom.
   Li activation energy barrier of 0.54 eV (1-dimensional), 0.54 (2-dimensional), 0.62 eV (3-dimensional).
   The reduction potential against lithium is 0 V, suggesting a high stability against Li metal, while the oxidation potential is 2.9 V.
   The reaction energy between the Li₈HfO₆ prototype and water (H₂O) is −0.48 eV/atom, suggesting a relatively stable compound against water.

Li₂HfO₃ crystallizes under 3 different space groups, namely, C2c, P6₃/mcm and Cmce.
Crystal Structure Description of C2/c: The phase is a Caswellsilverite-like structured. There are three inequivalent Li¹⁺ sites. In the first Li¹⁺ site, Li(1)¹⁺ is bonded to two equivalent O(1)²⁻, two equivalent O(2)²⁻, and two equivalent O(3)²⁻ atoms to form LiO₆ octahedra that share corners with two equivalent Li(3)O₆ octahedra, corners with two equivalent Hf(1)O₆ octahedra, corners with two equivalent Hf(2)O₆ octahedra, edges with two equivalent Li(3)O₆ octahedra, edges with two equivalent Hf(1)O₆ octahedra, edges with two equivalent Hf(2)O₆ octahedra, edges with three equivalent Li(1)O₆ octahedra, and edges with three equivalent Li(2)O₆ octahedra. The corner-sharing octahedral tilt angles range from 6-8°.
Properties of C2/c:
   The Li₂HfO₃ C2/c parent composition has an Ehull of 15 meV/atom.
   The Li activation energy barrier of 0.34 eV (1-dimensional), 0.49 (2-dimensional), 0.49 eV (3-dimensional).
   The reduction potential against lithium is 0.13 V, suggesting that this material can be used as anolyte against an alloy anode or graphite anode, while the oxidation potential is 3.47 V.
   The reaction energy between the Li₂HfO₃ prototype and water (H₂O) is 0 eV/atom, suggesting a high stability against water.
Crystal Structure Description of P6₃/mcm: Li₂HfO₃ under the P6₃/mcm is Caswellsilverite-like structured. There are two inequivalent Li1+ sites. In the first Li1+ site, Li(1)1+ is bonded to six equivalent O(1)2− atoms to form LiO6 octahedra that share corners with six equivalent Li(2)O6 pentagonal pyramids, edges with six equivalent Hf(1)O6 octahedra, and edges with six equivalent Li(2)O6 pentagonal pyramids. All Li(1)-O(1) bond lengths are 2.23 Å. In the second Li1+ site, Li(2)1+ is bonded to six equivalent O(1)2− atoms to form distorted LiO6 pentagonal pyramids that share corners with two equivalent Li(1)O6 octahedra, corners with four equivalent Hf(1)O6 octahedra, edges with two equivalent Li(1)O6 octahedra, edges with four equivalent Hf(1)O6 octahedra, and edges with six equivalent Li(2)O6 pentagonal pyramids. The corner-sharing octahedral tilt angles are 8°. There are two shorter (2.25 Å) and four longer (2.30 Å) Li(2)-O(1) bond lengths. Hf(1) 4+ is bonded to six equivalent O(1)2− atoms to form HfO6 octahedra that share corners with six equivalent Li(2)O6 pentagonal pyramids, edges with three equivalent Li(1)O6 octahedra, edges with three equivalent Hf(1)O6 octahedra, and edges with six equivalent Li(2)O6 pentagonal pyramids. All Hf(1)-O(1) bond lengths are 2.09 Å. O(1)2− is bonded to one Li(1)1+, three equivalent Li(2)1+, and two equivalent Hf(1)4+ atoms to form a mixture of face, corner, and edge-sharing OLi4Hf2 octahedra. The corner-sharing octahedral tilt angles range from 0-50°.
Properties of P6₃/mcm:
   The Li₂HfO₃ P6₃/mcm parent composition an Ehull of 48 meV/atom.
   The Li activation energy barrier of 0.74 eV (1-dimensional), 0.74 (2-dimensional), 0.75 eV (3-dimensional).
   The reduction potential against lithium is 0.13 V, suggesting that this material can be used as anolyte against an alloy anode or graphite anode, while the oxidation potential is 3.47 V.
   The reaction energy between the Li₂HfO₃ prototype and water (H₂O) is 0 eV/atom, suggesting a high stability against water.
Crystal Structure Description of Cmce: Li2HfO3 crystallizes in the orthorhombic Cmce space group. There are two inequivalent Li1+ sites. In the first Li1+ site, Li(1)1+ is bonded to four equivalent O(1)2− atoms to form distorted LiO4 trigonal pyramids that share corners with four equivalent Hf(1)O6 octahedra, corners with four equivalent Li(2)O4 tetrahedra, edges with two equivalent Hf(1)O6 octahedra, and edges with two equivalent Li(1)O₄ trigonal pyramids. The corner-sharing octahedral tilt angles range from 14-65°. There are two shorter (1.94 Å) and two longer (2.06 Å) Li(1)-O(1) bond lengths. In the second Li1+ site, Li(2)1+ is bonded to two equivalent O(1)2− and two equivalent O(2)2− atoms to form LiO4 tetrahedra that share corners with eight equivalent Hf(1)O6 octahedra, corners with two equivalent Li(2)O4 tetrahedra, and corners with four equivalent Li(1)O4 trigonal pyramids. The corner-sharing octahedral tilt angles range from 52-69°. Both Li(2)-O(1) bond lengths are 2.09 Å. There is one shorter (2.06 Å) and one longer (2.22 Å) Li(2)-O(2) bond length.
Properties of Cmce:
   The Li₂HfO₃ Cmce parent composition an Ehull of 49 meV/atom.
   The Li activation energy barrier of 0.30 eV (1-dimensional), 0.37 (2-dimensional), 0.68 eV (3-dimensional).
   The reduction potential against lithium is 0.13 V, suggesting that this material can be used as anolyte against an alloy anode or graphite anode, while the oxidation potential is 3.47 V.
   The reaction energy between the Li₂HfO₃ prototype and water (H2O) is 0 eV/atom, suggesting a high stability against water.

Li₄Hf₃O₈ crystallizes under two space groups P4₁32 and R-3m.
Crystal Structure Description of P4₁32: The P4₁32 cubic phase two inequivalent Li1+ sites. In the first Li1+ site, Li(1)1+ is bonded to six equivalent O(1)2− atoms to form LiO6 octahedra that share corners with six equivalent Li(2)O6 octahedra, edges with three equivalent Li(2)O6 octahedra, and edges with six equivalent Hf(1)O6 octahedra. The corner-sharing octahedral tilt angles are 13°. All Li(1)-O(1) bond lengths are 2.28 Å. In the second Li1+ site, Li(2)1+ is bonded to two equivalent O(2)2− and four equivalent O(1)2− atoms to form LiO6 octahedra that share corners with two equivalent Li(1)O6 octahedra, corners with four equivalent Hf(1)O6 octahedra, an edge-edge with one Li(1)O6 octahedra, edges with four equivalent Li(2)O6 octahedra, and edges with five equivalent Hf(1)O6 octahedra. The corner-sharing octahedral tilt angles range from 9-13°.
Properties of P4₁32:
   The Li₄Hf₃O₈ P4₁32 parent composition an Ehull of 40 meV/atom.
   The Li activation energy barrier of 0.30 eV (1-dimensional), 0.30 (2-dimensional), 0.30 eV (3-dimensional).
   The reduction potential against lithium is 0.46 V, suggesting that this material can be used as anolyte against an alloy anode or graphite anode, while the oxidation potential is 3.47 V.
   The reaction energy between the Li₄Hf₃O₈ prototype and water (H₂O) is 0 eV/atom, suggesting a high stability against water.
Crystal Structure Description of R-3m: The R-3m trigonal phase has three inequivalent Li1+ sites. In the first Li1+ site, Li(1)1+ is bonded in a 4-coordinate geometry to one O(1)2− and three equivalent O(2)2− atoms. The Li(1)-O(1) bond length is 1.89 Å. All Li(1)-O(2) bond lengths are 2.19 Å. In the second Li1+ site, Li(2)1+ is bonded to six equivalent O(2)2− atoms to form LiO6 octahedra that share corners with six equivalent Li(3)O6 octahedra and edges with six equivalent Hf(1)O6 octahedra. The corner-sharing octahedral tilt angles are 11°.
Properties of R-3m:
   The Li₄Hf₃O₈ R-3m parent composition an Ehull of 50 meV/atom.
   Li activation energy barrier of 0.28 eV (1-dimensional), 0.28 (2-dimensional), 0.39 eV (3-dimensional).
   The reduction potential against lithium is 0.46 V, suggesting that this material can be used as anolyte against an alloy anode or graphite anode, while the oxidation potential is 3.47 V.
   The reaction energy between the Li₄Hf₃O₈ prototype and water (H₂O) is 0 eV/atom, suggesting a high stability against water.

Li₆HfO₅ crystallizes under 3 space groups, namely, 14 mm, P-1, Cmcm.
Crystal Structure Description of 14 mm: The 14 mm tetragonal phase has two inequivalent Li1+ sites. In the first Li1+ site, Li(1)1+ is bonded to four equivalent O(2)2− atoms to form LiO4 tetrahedra that share corners with four equivalent Hf(1)O5 trigonal bipyramids, corners with eight equivalent Li(2)O₅ trigonal bipyramids, edges with two equivalent Li(1)O4 tetrahedra, and edges with four equivalent Li(2)O5 trigonal bipyramids. There are two shorter (1.89 Å) and two longer (1.96 Å) Li(1)-O(2) bond lengths. In the second Li1+ site, Li(2)1+ is bonded to one O(1)2− and four equivalent O(2)2− atoms to form distorted LiO5 trigonal bipyramids that share corners with four equivalent Li(1)O4 tetrahedra, a corner-corner with one Hf(1)O5 trigonal bipyramid, corners with seven equivalent Li(2)O5 trigonal bipyramids, edges with two equivalent Li(1)O4 tetrahedra, edges with two equivalent Hf(1)O5 trigonal bipyramids, and edges with four equivalent Li(2)O5 trigonal bipyramids.
Properties of I4 mm:
   The Li₆HfO₅ 14 mm parent composition an Ehull of 31 meV/atom.
   Li activation energy barrier of 0.41 eV (1-dimensional), 0.45 (2-dimensional), 0.45 eV (3-dimensional).
   The reduction potential against lithium is 0 V, suggesting that this material is stable against Li metal, while the oxidation potential is 2.9 V.
   The reaction energy between the Li₆HfO₅ prototype and water (H₂O) is −0.54 eV/atom, suggesting a relative stability against water.
Crystal Structure Description of P-1: The P-1 phase Li6HfO5 has three inequivalent Li1+ sites. In the first Li1+ site, Li(1)1+ is bonded to two equivalent O(1)2− and two equivalent O(3)2− atoms to form LiO4 tetrahedra that share corners with four equivalent Hf(1)O6 octahedra and edges with two equivalent Li(1)O₄ tetrahedra. The corner-sharing octahedral tilt angles range from 41-48°. There is one shorter (1.92 Å) and one longer (1.93 Å) Li(1)-O(1) bond length. There is one shorter (1.92 Å) and one longer (1.95 Å) Li(1)-O(3) bond length. In the second Li1+ site, Li(2)1+ is bonded in a 5-coordinate geometry to one O(2)2−, one O(3)2−, and three equivalent O(1)2− atoms.
Properties of P-1:
   The Li₆HfO₅ P-1 parent composition an Ehull of 42 meV/atom.
   Li activation energy barrier of 0.38 eV (1-dimensional), 0.94 (2-dimensional), 0.99 eV (3-dimensional).
   The reduction potential against lithium is 0 V, suggesting that this material is stable against Li metal, while the oxidation potential is 2.9 V.
   The reaction energy between the Li₆HfO₅ prototype and water (H₂O) is −0.59 eV/atom, suggesting a relative stability against water.

Li6HfO5 crystallizes in the orthorhombic Cmcm space group.
Crystal Structure Description: There are three inequivalent Li1+ sites. In the first Li1+ site, Li(1)1+ is bonded to four equivalent O(2)2− atoms to form LiO4 tetrahedra that share corners with four equivalent Li(2)O5 trigonal bipyramids, corners with four equivalent Hf(1)O5 trigonal bipyramids, edges with two equivalent Li(1)O₄ tetrahedra, and edges with two equivalent Li(2)O5 trigonal bipyramids. There are two shorter (1.90 Å) and two longer (2.02 Å) Li(1)-O(2) bond lengths. In the second Li1+ site, Li(2)1+ is bonded to one O(1)2− and four equivalent O(2)2− atoms to form distorted LiO5 trigonal bipyramids that share corners with four equivalent Li(1)O4 tetrahedra, a corner-corner with one Li(2)O5 trigonal bipyramid, a corner-corner with one Hf(1)O5 trigonal bipyramid, edges with two equivalent Li(1)O4 tetrahedra, edges with two equivalent Li(2)O5 trigonal bipyramids, and edges with two equivalent Hf(1)O₅ trigonal bipyramids.
Properties:
   The Li₆HfO₅ Cmem parent composition an Ehull of 51 meV/atom.
Li activation energy barrier of 0.36 eV (1-dimensional), 0.42 (2-dimensional), 0.51 eV (3-dimensional).
The reduction potential against lithium is 0 V, suggesting that this material is stable against Li metal, while the oxidation potential is 2.9 V.
The reaction energy between the Li6HfO5 prototype and water (H₂O) is −0.59 eV/atom, suggesting a relative stability against water.

Li4HfO4 crystallizes in the P-1 phase.
Crystal Structure Description: There are ten inequivalent Li1+ sites. In the first Li1+ site, Li(1)1+ is bonded to one O(1)2−, one O(10)2−, one O(3)2−, one O(4)2−, and one O(5)2− atom to form LiO5 square pyramids that share corners with two equivalent Hf(2)O6 octahedra, corners with two equivalent Li(4)O5 square pyramids, an edge-edge with one Hf(1)O6 octahedra, an edge-edge with one Hf(2)O6 octahedra, an edge-edge with one Hf(3)O6 octahedra, an edge-edge with one Li(2)O5 square pyramid, and edges with two equivalent Li(10)O5 square pyramids. The corner-sharing octahedral tilt angles range from 6-15°.
Properties:
   The Li₄HfO₄ Cmem parent composition an Ehull of 38 meV/atom.
   Li activation energy barrier of 0.23 eV (1-dimensional), 0.32 (2-dimensional), 0.31 eV (3-dimensional).
   The reduction potential against lithium is 0 V, suggesting that this material is stable against Li metal, while the oxidation potential is 2.9 V.
   The reaction energy between the Li₄HfO₄ prototype and water (H₂O) is −0.451 eV/atom, suggesting a relative stability against water.

High-throughput data-mining was conducted to derive novel prototype Li-containing structures, and advanced data analytics was performed to extract novel Li-ion conductors that are stable against Li metal, stable anolyte against various types of anodes such as alloy anode or graphite anode, stable catholytes and stable coating materials in all-solid state batteries.

The lithium-containing oxides in this disclosure can be made by a standard solid-state method. In this method, precursor powders are combined in a certain ratio depending on the composition of the target material. As one example, precursors may consist of lithium carbonate (Li₂CO₃) and hafnium oxide (HfO₂), and as another example, precursors may consist of lithium oxide (Li₂O) and hafnium oxide. Examples of metal precursors include metal oxides, hydroxides, carbonates, and nitrates. For instance, the compounds described in this disclosure may be prepared using the precursors tantalum oxide and titanium oxide as sources of the associated metal ions.

The precursor mixture may be mixed by a method such as ball milling or planetary milling to produce a homogeneous mixture. Mixing may be done with a suitable solvent such as ethanol, isopropanol, ethylene glycol, or acetone to assist with the uniform dispersion of the precursors.

The precursor mixture may then be heat treated to an appropriate temperature (e.g., 500-1000° C.) for an appropriate period of time (e.g., 6-12 hours) to produce a powder with the desired composition and crystal structure.

Subsequently, the powder may be compressed using a hydraulic uniaxial press to form a densely packed pellet. Heat treatment may then be applied at an appropriate temperature (e.g., 500-1000° C.) for an appropriate period of time (e.g., 6-12 hours) to produce a dense pellet which may be used as a solid electrolyte separator in a solid state lithium battery cell.

An embodiment of the aforementioned solid electrolyte separator can be assembled together with a cathode active material layer and an anode active material layer to be used in an embodiment which is a solid state lithium battery comprising a cathode active material layer, an anode active material layer, and a solid electrolyte layer formed between the cathode active material layer and the anode active material layer, wherein the solid electrolyte layer comprises any of the aforementioned materials.

The lithium-containing oxides in this disclosure can be used as a solid electrolyte material for Li batteries.

This disclosure provides lower cost/high conductivity and high aqueous stability solid electrolyte for use in Li solid-state batteries.

### EXAMPLES

Embodiments will now be illustrated by way of the following examples, which do not limit the embodiments in any way.

A machine learning-based crystal structure prediction algorithm was applied to obtain the following compositions as set forth in Table 1.

TABLE 1

| | | | | | | | | | | H2O | | |
|---|---|---|---|---|---|---|---|---|---|---|---|---|
| Host | | Chemical | Mobile | | | | | | | R × N | H2O | |
| ID | Formula | Space | Ion | E_1D | E_2D | E_3D | Ehull | Vred | Vox | Energy | Content | SPG |
| 27813 | Li6Hf2O7 | Hf—Li—O | Li1+ | 0.61 | 0.99 | 0.99 | 5.41 | −0.0 | 3.22 | −0.18 | 0.5 | P2₁/c |
| 27693 | Li8HfO6 | Hf—Li—O | Li1+ | 0.54 | 0.54 | 0.62 | 6.8 | −0.0 | 2.9 | −0.48 | 0.71 | R-3 |
| 27697 | Li8HfO6 | Hf—Li—O | Li1+ | 0.54 | 0.54 | 0.62 | 7.06 | −0.0 | 2.9 | −0.48 | 0.71 | R-3 |
| 27898 | Li2HfO3 | Hf—Li—O | Li1+ | 0.34 | 0.49 | 0.49 | 15.61 | 0.13 | 3.47 | 0.0 | 1.0 | C2/c |
| 27840 | Li6HfO5 | Hf—Li—O | Li1+ | 0.41 | 0.45 | 0.45 | 31.26 | −0.0 | 2.9 | −0.54 | 0.6 | I4 mm |
| 27712 | Li4HfO4 | Hf—Li—O | Li1+ | 0.23 | 0.32 | 0.32 | 38.2 | −0.0 | 2.9 | −0.45 | 0.33 | P-1 |
| 27779 | Li4Hf3O8 | Hf—Li—O | Li1+ | 0.3 | 0.3 | 0.3 | 40.01 | 0.46 | 3.47 | 0.0 | 1.0 | P4₁32 |
| 27741 | Li6HfO5 | Hf—Li—O | Li1+ | 0.38 | 0.94 | 0.99 | 42.66 | −0.0 | 2.9 | −0.59 | 0.6 | P-1 |
| 27605 | Li2HfO3 | Hf—Li—O | Li1+ | 0.74 | 0.75 | 0.75 | 48.6 | 0.13 | 3.47 | 0.0 | 1.0 | P6₃/mcm |
| 27854 | Li2HfO3 | Hf—Li—O | Li1+ | 0.3 | 0.37 | 0.68 | 49.08 | 0.13 | 3.47 | 0.0 | 1.0 | Cmce |
| 27618 | Li4Hf3O8 | Hf—Li—O | Li1+ | 0.28 | 0.28 | 0.39 | 50.25 | 0.46 | 3.47 | 0.0 | 1.0 | R-3m |
| 28006 | Li6HfO5 | Hf—Li—O | Li1+ | 0.36 | 0.42 | 0.51 | 51.41 | −0.0 | 2.9 | 0.64 | 0.6 | Cmcm |
| 27858 | Li4HfO4 | Hf—Li—O | Li1+ | 0.39 | 0.64 | 0.92 | 53.32 | −0.0 | 2.9 | −0.54 | 0.33 | P1 |
| 28033 | Li4HfO4 | Hf—Li—O | Li1+ | 0.45 | 0.65 | 0.65 | 54.03 | −0.0 | 2.9 | −0.54 | 0.33 | Cmcm |
| 27715 | Li2HfO3 | Hf—Li—O | Li1+ | 0.19 | 0.28 | 0.92 | 56.18 | 0.13 | 3.47 | 0.0 | 1.0 | C2/c |
| 27785 | Li4HfO4 | Hf—Li—O | Li1+ | 0.43 | 0.6 | 0.86 | 57.29 | −0.0 | 2.9 | −0.56 | 0.33 | P-1 |

As can be seen from the results presented in Table 1, the reduction potential against lithium is 0 V for Li₆Hf₂O₇, suggesting a high stability against Li metal, while the oxidation potential is 3.22 V (again, in batteries, this material as solid-state electrolyte can form solid-electrolyte interphases by chemical reaction with electrodes and widen the redox potential window of the electrolyte; this applies to the materials below as well), and the reaction energy between the Li₆Hf₂O₇ prototype and water (H₂O) is −0.18 eV/atom, suggesting a relatively stable compound against water. Also, the reduction potential against lithium is 0 V for Li₈HfO₆, suggesting a high stability against Li metal, while the oxidation potential is 2.9 V, and the reaction energy between the Li₈HfO₆ prototype and water is −0.48 eV/atom, suggesting a relatively stable compound against water. In addition, the reduction potential against lithium is 0.13 V for Li₂HfO₃, suggesting that this material can be used as anolyte against an alloy anode or graphite anode, while the oxidation potential is 3.47 V, and the reaction energy between the Li₂HfO₃ prototype and water is 0 eV/atom, suggesting a high stability against water. Further, the reduction potential against lithium is 0.46 V for Li₄Hf₃O₈, suggesting that this material can be used as anolyte against an alloy anode or graphite anode, while the oxidation potential is 3.47 V, and the reaction energy between the Li₄Hf₃O₈ prototype and water is 0 eV/atom, suggesting a high stability against water. Moreover, the reduction potential against lithium is 0 V for Li₆HfO₅, suggesting that this material is stable against Li metal, while the oxidation potential is 2.9 V, and the reaction energy between the Li₆HfO₅ prototype and water is −0.59 eV/atom, suggesting a relative stability against water. Additionally, reduction potential against lithium is 0 V for Li₄HfO₄, suggesting that this material is stable against Li metal, while the oxidation potential is 2.9 V, and the reaction energy between the Li₄HfO₄ prototype and water is, e.g., −0.451 eV/atom, suggesting a relative stability against water.

The foregoing is illustrative of exemplary embodiments and is not to be construed as limiting the disclosure. Although a few exemplary embodiments have been described, those skilled in the art will readily appreciate that many modifications are possible in the above embodiments without materially departing from the disclosure.

What is claimed is:

1. A lithium hafnium oxide of one of the following parent compositions:
Li_{6-z}Hf₂₋ₓMₓO₇ crystallized in space group P2₁/c,
Li_{8-z}Hf₁₋ₓMₓO₆ crystallized in space group R-3,
Li_{2-z}Hf₁₋ₓMₓO₃,
Li_{4-z}Hf₃₋ₓMₓO₈,
Li_{6-z}Hf₁₋ₓMₓO₅, or
Li_{4-z}Hf₁₋ₓMₓO₄ crystallized in space group P-1 or Cmcm,
wherein M can be either a one-way, two-way or three-way combination of the following species: Sc³⁺, Y³⁺, Lu³⁺, Ti³⁺, Ti⁴⁺, Zr⁴⁺, Ta³⁺, Ta⁴⁺, Ta⁵⁺, Cr³⁺, Cr⁴⁺, Cr⁵⁺, Fe³⁺, Fe⁴⁺, Mn³⁺, Al³⁺, Ga³⁺, In³⁺, La³⁺, Ce⁴⁺, Ce³⁺,
wherein charge neutrality is satisfied, and
wherein −1<z<1 and x can be from 0 to the maximum stoichiometric amount of hafnium in each respective compound.

2. The lithium hafnium oxide of claim 1, wherein the lithium hafnium oxide is a lithium hafnium oxide of the parent composition Li_{6-z}Hf₂₋ₓMₓO₇ crystallized in space group P2₁/c,
wherein M can be either a one-way, two-way or three-way combination of the following species: Sc³⁺, Y³⁺, Lu³⁺, Ti³⁺, Ti⁴⁺, Zr⁴⁺, Ta³⁺, Ta⁴⁺, Ta⁵⁺, Cr³⁺, Cr⁴⁺, Cr⁵⁺, Fe³⁺, Fe⁴⁺, Mn³⁺, Al¹³⁺, Ga³⁺, In³⁺, La³⁺, Ce⁴⁺, Ce³⁺,
wherein charge neutrality is satisfied, and
wherein −1<z<1 and x can be from 0 to the maximum stoichiometric amount of hafnium in each respective compound.

3. The lithium hafnium oxide of claim 1, wherein the lithium hafnium oxide is a lithium hafnium oxide of the parent composition Li_{8-z}Hf₁₋ₓMₓO₆ crystallized in space group R-3,
wherein M can be either a one-way, two-way or three-way combination of the following species: Sc³⁺, Y³⁺, Lu³⁺, Ti³⁺, Ti⁴⁺, Zr⁴⁺, Ta³⁺, Ta⁴⁺, Ta⁵⁺, Cr³⁺, Cr⁴⁺, Cr⁵⁺, Fe³⁺, Fe⁴⁺, Mn³⁺, Al³⁺, Ga³⁺, In³⁺, La³⁺, Ce⁴⁺, Ce³⁺,
wherein charge neutrality is satisfied, and
wherein −1<z<1 and x can be from 0 to the maximum stoichiometric amount of hafnium in each respective compound.

4. The lithium hafnium oxide of claim 1, wherein the lithium hafnium oxide is a lithium hafnium oxide of the parent composition Li_{2-z}Hf₁₋ₓMₓO₃,
wherein M can be either a one-way, two-way or three-way combination of the following species: Sc³⁺, Y³⁺, Lu³⁺, Ti³⁺, Ti⁴⁺, Zr⁴⁺, Ta³⁺, Ta⁴⁺, Ta⁵⁺, Cr³⁺, Cr⁴⁺, Cr⁵⁺, Fe³⁺, Fe⁴⁺, Mn³⁺, Al³⁺, Ga³⁺, In³⁺, La³⁺, Ce⁴⁺, Ce³⁺,
wherein charge neutrality is satisfied, and
wherein −1<z<1 and x can be from 0 to the maximum stoichiometric amount of hafnium in each respective compound.

5. The lithium hafnium oxide of claim 1, wherein the lithium hafnium oxide is a lithium hafnium oxide of the parent composition Li_{4-z}Hf₃₋ₓMₓO₈,
wherein M can be either a one-way, two-way or three-way combination of the following species: Sc³⁺, Y³⁺, Lu³⁺, Ti³⁺, Ti⁴⁺, Zr⁴⁺, Ta³⁺, Ta⁴⁺, Ta⁵⁺, Cr³⁺, Cr⁴⁺, Cr⁵⁺, Fe³⁺, Fe⁴⁺, Mn³⁺, Al¹³⁺, Ga³⁺, In³⁺, La³⁺, Ce⁴⁺, Ce³⁺,
wherein charge neutrality is satisfied, and
wherein −1<z<1 and x can be from 0 to the maximum stoichiometric amount of hafnium in each respective compound.

6. The lithium hafnium oxide of claim 1, wherein the lithium hafnium oxide is a lithium hafnium oxide of the parent composition Li_{6-z}Hf₁₋ₓMₓO₅,
wherein M can be either a one-way, two-way or three-way combination of the following species: Sc³⁺, Y³⁺, Lu³⁺, Ti³⁺, Ti⁴⁺, Zr⁴⁺, Ta³⁺, Ta⁴⁺, Ta⁵⁺, Cr³⁺, Cr⁴⁺, Cr⁵⁺, Fe³⁺, Fe⁴⁺, Mn³⁺, Al³⁺, Ga³⁺, In³⁺, La³⁺, Ce⁴⁺, Ce³⁺,
wherein charge neutrality is satisfied, and
wherein −1<z<1 and x can be from 0 to the maximum stoichiometric amount of hafnium in each respective compound.

7. The lithium hafnium oxide of claim 1, wherein the lithium hafnium oxide is a lithium hafnium oxide of the parent composition Li_{4-z}Hf₁₋ₓMₓO₄ crystallized in space group P-1 or Cmcm,
wherein M can be either a one-way, two-way or three-way combination of the following species: Sc³⁺, Y³⁺, Lu³⁺, Ti³⁺, Ti⁴⁺, Zr⁴⁺, Ta³⁺, Ta⁴⁺, Ta⁵⁺, Cr³⁺, Cr⁴⁺, Cr⁵⁺, Fe³⁺, Fe⁴⁺, Mn³⁺, Al³⁺, Ga³⁺, In³⁺, La³⁺, Ce⁴⁺, Ce³⁺,
wherein charge neutrality is satisfied, and
wherein −1<z<1 and x can be from 0 to the maximum stoichiometric amount of hafnium in each respective compound.

8. The lithium hafnium oxide of claim 1, wherein the lithium hafnium oxide is Li₆Hf₂O₇ crystallized in space group P2₁/c.

9. The lithium hafnium oxide of claim 1, wherein the lithium hafnium oxide is Li₈HfO₆ crystallized in space group R-3.

10. The lithium hafnium oxide of claim 1, wherein the lithium hafnium oxide is Li₂HfO₃.

11. The lithium hafnium oxide of claim 1, wherein the lithium hafnium oxide is Li₄Hf₃O₈.

12. The lithium hafnium oxide of claim 1, wherein the lithium hafnium oxide is Li₆HfO₅.

13. The lithium hafnium oxide of claim 1, wherein the lithium hafnium oxide is Li₄HfO₄ crystallized in space group P-1 or Cmcm.

14. The lithium hafnium oxide of claim 1, wherein the lithium hafnium oxide is:
Li₆Hf₂O₇ crystallized in space group P2₁/c,
Li₈HfO₆ crystallized in space group R-3,
Li₂HfO₃ crystallized in space group C2/c,
Li₂HfO₃ crystallized in space group P6₃/mcm,
Li₂HfO₃ crystallized in space group Cmce,
Li₄Hf₃O₈ crystallized in space group P4₁32,
Li₄Hf₃O₈ crystallized in space group R-3m,
Li₆HfO₅ crystallized in space group I4 mm,
Li₆HfO₅ crystallized in space group P-1,
Li₆HfO₅ crystallized in space group Cmcm,
Li₄HfO₄ crystallized in space group P-1, or
Li₄HfO₄ crystallized in space group Cmcm.

15. A lithium solid-state battery comprising an anode, a cathode, and a solid electrolyte, wherein the solid electrolyte comprises a lithium hafnium oxide of claim 1.

16. The lithium solid-state battery of claim 15, wherein the solid electrolyte comprises Li₆Hf₂O₇ crystallized in space group P2₁/c, Li₈HfO₆ crystallized in space group R-3, Li₂HfO₃, Li₄Hf₃O₈, Li₆HfO₅, Li₄HfO₄ crystallized in space group P-1, or Li₄HfO₄ crystallized in space group Cmcm.

17. The lithium solid-state battery of claim 15, wherein the solid electrolyte comprises Li₂HfO₃, Li₄Hf₃O₈, or Li₆HfO₅.

18. A lithium solid-state battery comprising an anode, a cathode, and a solid electrolyte, wherein at least one of the anode and the cathode is coated with a coating which comprises a lithium-containing oxide of claim 1.

19. The lithium solid-state battery of claim 18, wherein the coating comprises Li₆Hf₂O₇ crystallized in space group P2₁/c, Li₈HfO₆ crystallized in space group R-3, Li₂HfO₃, Li₄Hf₃O₈, Li₆HfO₅, or Li₄HfO₄ crystallized in space group P-1 or Cmcm.

20. The lithium solid-state battery of claim 18, wherein the cathode is coated with the coating which comprises the lithium-containing oxide.
